(19) United States
(12) Patent Application Publication
(10) Pub. No.: US 2013/0076613 A1
(43) Pub. Date: Mar. 28, 2013

(54) POWERED MARKING APPARATUS FOR POINTING CONTROL

(71) Applicant: Anta TRIMUA, Redmond, WA (US)

(72) Inventor: Anta TRIMUA, Redmond, WA (US)

(73) Assignee: NINTENDO OF AMERICA, REDMOND, WA (US)

(21) Appl. No.: 13/247,701

(22) Filed: Sep. 28, 2011

(51) Int. Cl. G09G 5/00

(52) U.S. Cl. 345/156; 345/2.1; 398/106

(57) ABSTRACT

Certain aspects relate to a cordless powered light marking apparatus that can be used with a pointing device and information processor to enable a program to be executed by the information processor. In certain embodiments, the cordless light marking apparatuses are “solar-powered.” In some cases, the cordless light marking apparatus may be self-powered in a different manner, such as via rechargeable batteries (e.g., lithium ion), alkaline batteries, etc. Other aspects relate to applications of the cordless light marking apparatuses. For example, multiple display devices connected directly or indirectly to one information processor may each have a light marking apparatus, enabling multiple players to interact substantially simultaneously with the same information processor through different display devices and different pointing devices. Further, the information processor may be accessed at different times through different display devices, without needing to move the processor or light marking apparatus.

### FIELD

Technology herein relates to cordless optical markers of the type that can be used in pointing systems. In certain embodiments, the cordless markers may be powered by a portable power sources such as photovoltaic “solar-powered” devices. Other aspects relate to different applications of cordless self-powered light marking arrays/apparatuses. For example and without limitation, by using solar and/or self-powered light marking arrays/apparatuses, multiple display devices and/or modules connected directly or indirectly to an information processor including at least one processor may be able to each have a light marking array/apparatus, thereby enabling multiple players to play against each other on different TVs, from different locations, through the same information processor.

### BACKGROUND AND SUMMARY

It is known to use a light marking apparatus (e.g., comprising plural point source arrays) and associated optical detector(s) to permit a hand held or other device (e.g. a video game controller, computer game controller, keyboard, mouse, and/or the like) to point. For example, pointing may be accomplished by using a computer-based camera device or other light sensor or detector to automatically ascertain where the device is pointing by detecting points of infrared light or other illumination. The device or detector may “see” two or more spaced apart infrared light sources, and use detected coordinating of the light sources with the optical detecting viewing frame to ascertain where the device is pointing. In other words, analogizing to a laser pointer that can aim at a particular spot on a screen, a light detector provided with appropriate processing capabilities (e.g., software and/or hardware) can determine some aspects of where an associated device is pointing based on received and detected light patterns.

FIG. 1 shows an example embodiment of a light marking apparatus. The light marking bar/apparatus 108c depicted in FIG. 1 includes an elongated bar-shaped housing comprising light sources 108a, 108b, and cord 103 that connects bar 108c to a power source such as information processor 100. A power source is needed in order for power to be provided to the light sources 108a, 108b. The power source may include electrical outlets, information processors, processors, game consoles or other electronic equipment, display modules, or the like, in other example embodiments.

With reference to FIG. 1, light marking apparatus 108c comprises an elongated member such as a bar shaped housing including spaced-apart point light sources 108a and 108b is provided. The point sources could be disposed within a housing of any shape, could be in separate housings, could be included in the display's housing, and the like. In one exemplary illustrative non-limiting implementation, the elongated member may have first and second ends 5 and 7. A point source may be disposed on each end or anywhere else along the housing. In one exemplary illustrative non-limiting implementation, the spacing between the two spaced-apart point sources may be 20 centimeters or more. The point sources could be closer together or further apart.

In one exemplary illustrative non-limiting implementation, the point sources 108a, 108b can be generally oriented to emit light within a common horizontal plane or into different planes (e.g, some upwardly, some downwardly, etc.). Such 3D directionality can provide a potentially wider coverage area horizontally and/or vertically. The point sources could use a single point source in each array, or the point sources may use a plurality of point sources in each array. The point source arrays could be oriented in varying directions or in the same direction.

In an exemplary illustrative non-limiting implementation, each point source 108a, 108b comprises an array of plural point illumination sources. The plural point illumination sources in each array may be directional. The point sources 108a, 108b may be aimed in different directions to provide different illumination patterns. For example, some (e.g., three) of the point sources 108a, 108b can have a primary radiation directionality (lobes) that is substantially perpendicular to a front face of the bar-like structure, whereas other point sources 108a, 108b can have primary radiation directionalities (lobes) that define acute angles with respect to such perpendicular direction. In one exemplary illustrative non-limiting implementation, some of the point sources are directed forward, while others are directed outwardly, and still others are directed inwardly with respect to the elongated member. Such expanded irradiation coverage area can provide advantages for multi-player games or the like where two or more spaced-apart detection devices each independently detect the point sources from different positions. As can be seen from FIG. 1, cord 103 must be plugged into a power source in order to power light sources 108a, 108b, which then in turn permit a handheld device such as controller 107 to communicate position information to a information processor 100, as described above. In some cases, cord 103 may not be long enough to be used with a display device and still be plugged into a power source (e.g., the information processor, processor, game console, the display device, a wall outlet, and the like). In other cases, if a power source is not within close enough proximity to light marking apparatus 108c and cord 103, the bar 108c may not be able to receive electricity and/or power. Thus, it will be appreciated that there is a need for a cordless and/or wireless light marking apparatus; particularly with self-powered capabilities. Furthermore, in certain example embodiments there may also be a need for a cordless light marking apparatus that does not require batteries and/or that is required to turn off every couple of hours to conserve energy. In other words, it will be appreciated that a cordless light marking apparatus capable of recharging would be advantageous.

Some such marker light arrays as described above are wired, others are wireless, and some are built into display devices. Many of the wireless light arrays require batteries that need to be replaced periodically to ensure proper functioning. Meanwhile, some such wired light arrays are essentially physically anchored close to a device that powers the light bar, which may limit use. It would be desirable to provide more portable light arrays so they can be used in a wider variety of contexts.

Some aspects of the technology herein provide certain example embodiments relating to solar-powered and/or self-powered cordless “marking” light sources for pointing.

The technology herein provides exemplary illustrative non-limiting systems, methods, devices and techniques for supplying convenient and effective targeting or “marking” light sources for use with presentation surfaces including but not limited to 2D and 3D video display systems. Useful non-limiting applications include electronic and non-electronic displays of all types such as televisions, computer monitors, light projection systems, whiteboards, blackboards, easels and any other presentation or other surface imaginable. Such targeting or marking can be used for example to control cursors, other symbols or objects on electronic displays.

Certain example embodiments of the aforesaid marking structures that can be used with display modules in order to enable a handheld or other pointing or control device to detect where it is pointing relative to a variety of target surfaces, such as display surfaces. For example, using such techniques, it is possible to detect where a handheld pointing device aims relative to a display or other presentation surface. One example of such a handheld pointing device may be for example as described in US 2007/0066394, incorporated by reference. In other example embodiments, pointing, control and/or handheld “device” may refer to a video game controller, a computer game controller, a keyboard, a mouse, to name a few examples.

In an exemplary non-limiting implementation of a light marking apparatus comprising arrays with a plurality of point sources, the point sources in each array may emit the same or different light colors or frequencies of light. For example, one exemplary illustrative non-limiting implementation may provide, on each end of a rigid bar or other structure, an array of differently-aimed infrared point light sources, with the different point light sources emitting the same frequencies or wavelengths of infrared or other light. Other arrangements are possible. In certain example embodiments, a light marking apparatus comprises a light marking array. In other example embodiments, “light marking apparatus” and “light marking array” may be used interchangeably, though their meanings are not necessarily synonymous.

In an exemplary illustrative non-limiting implementation, the light marking apparatus may comprise a rigid bar or other structure that is especially adapted for mounting to the top, bottom, side or other dimension of an electronic display device such as a television set. Such light emitting bar structure can be mounted by a variety of convenient means including but not limited to adhesive tape, Velcro, gravity, interlocking parts, or any other desired mechanism. The device could also be affixed to a stand on which the display sits or to which the display is attached. Still other arrangements could provide structures that are integral or partially integral to display devices.

In certain example embodiments herein, an improved light marking apparatus described herein may advantageously be wireless and/or cordless, in the sense that it does not need to be plugged into a power source for its light source(s) to operate. The use of a cordless light marking apparatus may be advantageous in that (1) it permits the light marking apparatuses to be moved to different display modules without the need for untangling or unplugging wires; (2) it permits the light marking apparatuses to be used with a display device that is not proximate a power source (such as a information processor, processor, game console, outlet, or the like); and (3) it permits more than one light marking apparatus to be used in conjunction with only one information processor, according to other aspects of this invention.

A solar and/or self-powered light marking apparatus is designed to give a user the freedom of installing the light marking apparatus anywhere without having to worry about having a game system and/or console close by, in certain embodiments. This may be helpful for consumers with a theater system or using a big screen or a projection system. Having an information processor (e.g., a game console, computer, etc.) in the back of room and the remote at the front, even hidden in the wall, may be convenient for some consumers in some instances. Certain example embodiments resolve the problem of having to change the battery on the actual cordless light marking apparatus using a battery. Also, a Green energy light marking apparatus is a label the Company may use to tighten the relationship with Green consumers ideology.

Various IR signals/light sources on a bar can be used as a reference for a remote device as described above in order for the remote device. Generally, the light sources must remain plugged into a power source such as an information processor (e.g., computer, game console, etc.) for power. This makes it necessary for the bar to be located in close proximity to the console. In certain example embodiments, the bar and information processor will have to be associated with the same output device (e.g., a television, computer monitor, or the like).

Improvements herein relate to a cordless light marking apparatus. The cordless light marking apparatus may be solar-powered and/or self-powered in certain examples. In some instances, the cordless aspect of light marking apparatuses described herein may enable a plurality of said marking apparatuses to be used with a plurality of display devices, with one central system. This may enable multiple users to access a program run on the central system from display devices located in disparate locations from each other and/or from the central system. The cordless light marking apparatuses may further enable a user or plurality of users to interact with the program from the display devices located in disparate locations.

In certain example embodiments, a system may comprise an information processor generating display signals; a display signal distributor that distributes the display signals to a plurality of disparately-located display devices; a plurality of handheld controllers each capable of wireless communication with the processor, each said handheld controller including an optical detector; a plurality of light marking arrays associated with the respective plurality of disparately-located displays, each light marking array being proximate an associated display device; the information processor wirelessly receiving pointing signals from the plurality of handheld controllers in response to detection of said associated light marking arrays by said handheld controller optical detectors, said information processor processing said received pointing signals to generate display signals representing an animated display sequence for common display by the plurality of disparately-located display devices.

The cordless light marking apparatus may comprise: plural point source arrays, each array including at least one light source for supplying an unmodulated, substantially constant illumination intensity; at least one housing for supporting the plural point source arrays with a fixed predetermined distance therebetween, said housing between adapted to mount either above or beneath a display device; and at least solar energy conversion device, provided on said housing, wherein the cell provides power to the light source, wherein said light marking apparatus can, without modification or customization, be used with a variety of differently sized display devices.

In certain examples, a plurality of corresponding cordless and/or self-powered light marking apparatuses and display devices may be used with a single central system. One or more users may utilize the plurality of light marking apparatuses and display devices to access the central system at different times from disparate locations. In other embodiments, a plurality of users may utilize the plurality of light marking apparatuses and display devices to access the central system substantially simultaneously from disparate locations.

Other example embodiments relate to a method for using a cordless light marking apparatus with a display device connected to a central system such that multiple users may access a program that is run on the central system substantially simultaneously, using only one information processor connected to a central system, where each user has its own display device and cordless light marking apparatus.

### BRIEF DESCRIPTION OF THE DRAWINGS

FIG. 1 is a view of a prior art light marking apparatus.

FIGS. 2(a)-(d) are views of a light marking apparatus according to certain example embodiments.

FIG. 3 is a cross-sectional view of an example photovoltaic device.

FIG. 4 is a view of a light marking apparatus and a display module according to other example embodiments.

FIG. 5 is a block diagram showing display devices connecting to a centralized system, to which an information processor is also connected.

FIG. 6 is a block diagram showing display devices, each with a solar and/or self-powered cordless light marking apparatus, connecting to a centralized system, to which an information processor is also connected.

FIG. 7 is a diagram of three players playing a game from one information processor, substantially simultaneously, from different rooms.

FIG. 8 is a diagram of an example prior art game system 10.

FIG. 9 is a block diagram of example information processor 100 shown in FIG. 1.

FIGS. 10A and 10B are perspective views of a top and a bottom of example controller 107 shown in FIG. 1.

FIG. 11 is a front view of example controller 107 shown in FIG. 8.

FIG. 12A is a block diagram of example controller 107 shown in FIG. 8.

FIGS. 12B-1 to 12B-8 are used in an explanation of how a direction in which example controller 107 is pointing is determined.

FIG. 12C is used in an explanation of the pointing direction of example controller 107.

### DETAILED DESCRIPTION OF THE INVENTION

Certain example embodiments relate to solar-powered and/or self-powered cordless “marking” light sources (e.g., sensor bars) suitable for use with certain gaming systems, and methods related to using and/or making the same.

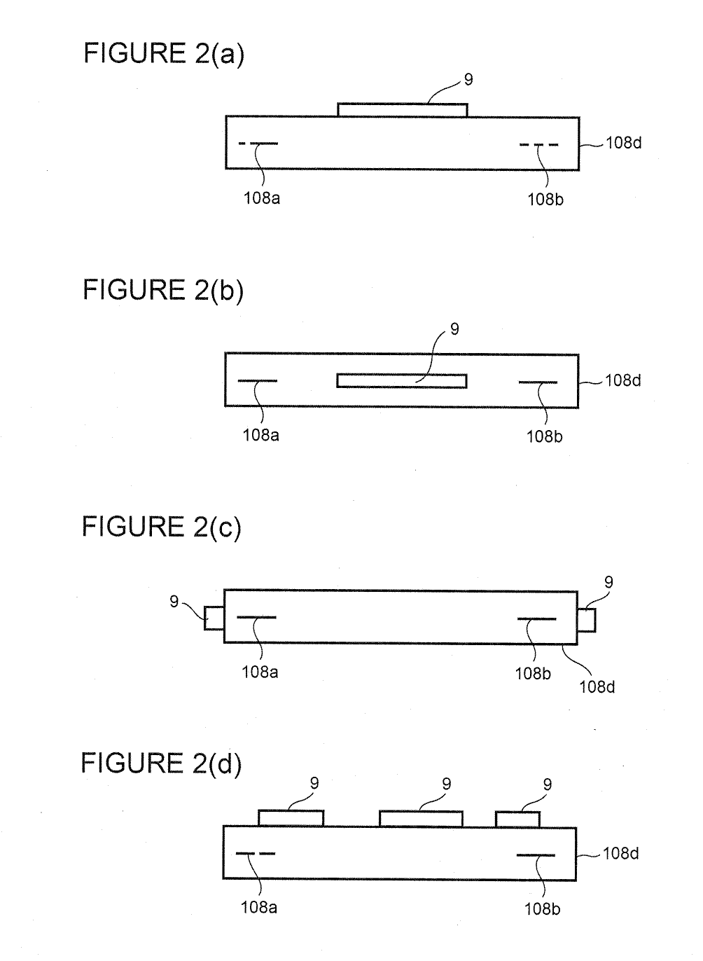

FIGS. 2(a)-(d) illustrate example embodiments of improved light marking apparatus 108d. In FIGS. 2(a)-(d), cord 103 is not necessary, and has been removed. Accordingly, a power source is no longer required, either. Instead, electromagnetic radiation converter 9 is provided on light marking apparatus 108d. In certain example embodiments, electromagnetic radiation converter 9 may be at least one of a solar cell, a solar panel, and/or a photovoltaic device. This cell, panel, and/or device may operate to convert any wavelength of electromagnetic radiation into electricity and/or energy to power the light source(s) 108a, 108b in the light marking apparatus.

A solar cell, photovoltaic cell or photoelectric cell is a solid state device that converts the energy of sunlight directly into electricity by the photovoltaic effect in certain non-limiting embodiments. Assemblies of cells are used to make solar modules, also known as solar panels. The energy generated from these solar modules, referred to as solar power, is an example of solar energy. Photovoltaic devices and solar cells are described generally in U.S. Pat. No. 4,629,821, which is herein incorporated by reference.

In certain example embodiments, the cordless light marking apparatus may derive its power from a solar energy source via electromagnetic radiation converter 9 (e.g. solar cell, solar panel, photovoltaic device, etc). For example, the cordless light marking apparatus 108d may have a photovoltaic device and/or solar cell located on the bar. In certain example embodiments, converter 9 may be on the top of the bar. In other example embodiments, there may be more than one converter 9 on the sensor bar. FIGS. 2(a)-(d) illustrate different example positions of the converter 9 on the cordless light marking apparatus 108d. In certain cases, a solar-powered light marking apparatus may include cells located at the ends of the light marking apparatus. In other example embodiments, the cell(s) may be located anywhere on the light marking apparatus so long as the cell(s) does/do not interfere with the light source(s)/IR transmitter(s).

The solar light marking apparatus 108d may advantageously be recharged without the need for plugging it in or replacing the batteries. Thus, in certain example embodiments, a light marking apparatus may be provided that is truly cordless. Furthermore, in some embodiments, the bar 108d will recharge itself via electromagnetic radiation, and therefore does not need to inconveniently be plugged in, or have its batteries changed, in order to recharge. Furthermore, because the solar light marking apparatus may recharge itself in certain example embodiments, it may not be necessary to turn off the light marking apparatus every few hours, as may be the case with a light marking apparatus that requires batteries or must be recharged via a wire.

In certain example embodiments relating to solar-powered light marking apparatuses, converter 9 may be positioned on the solar light marking apparatus so as to receive light and/or other types of electromagnetic radiation. This light and/or radiation is then converted to energy and/or electricity by converter 9 (e.g., a solar cell and/or photovoltaic device). This energy then powers the light sources 108a, 108b (e.g., IR transmitters; LED modules, and the like) of the light marking apparatus 108d, such that a handheld device (e.g., a controller 107) used with the light marking apparatus may adequately convey its position and/or location to a receiving device such as an information processor including an information processor such as a computer, game console, etc.

However, in other example embodiments, the cordless light marking apparatus may derive power from rechargeable batteries, alkaline batteries and/or the like. In these cases the light marking apparatus is still advantageously cordless and self-powered.

The cordless light marking apparatus described above may advantageously be used with a plurality of display devices located in disparate locations. This may enable one central processor or the like to execute a program that is accessible from a plurality of disparately located devices. Further, each display device may have a corresponding cordless light marking apparatus, which may permit a user or users to interact with the program from more than one display device and/or location.

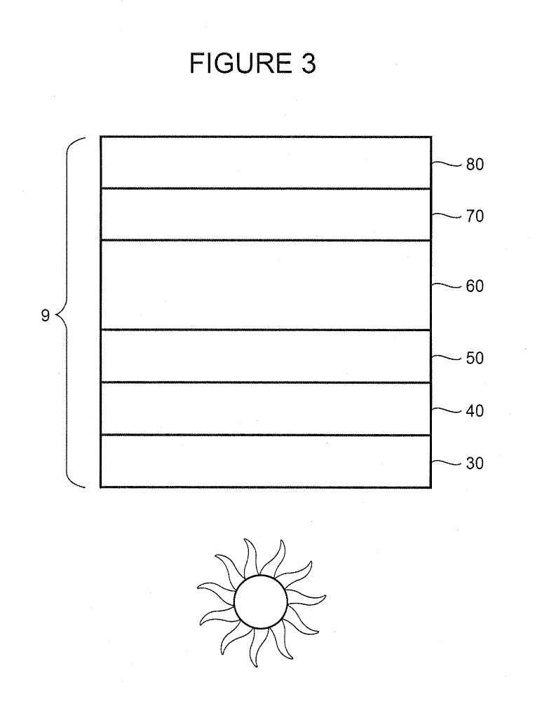

FIG. 3 illustrates a non-limiting example of a solar cell and/or photovoltaic device 9. FIG. 3 is a cross-sectional view of a cell. FIG. 3 shows light-incident transparent substrate 30. Layer 40 is disposed over transparent substrate 30, and comprises a front contact layer or layer stack, or a transparent conductive oxide coating, or a transparent conductive coating, and/or the like. Layer 50 comprises an optional buffer material. Layer 60 comprises a semiconductor. The semiconductor may be silicon, amorphous or crystalline, or may be of Cd, Te, Cs and/or the like. Layer 70 is an optional back contact layer, and is of or includes a metallic or metallic oxide-based material. Layer 80 is an optional back encapsulent, and may also be a transparent substrate (e.g., glass, plastic, etc). FIG. 3 is an example of a solar cell and/or photovoltaic device, and in no way limits the design of the converter 9.

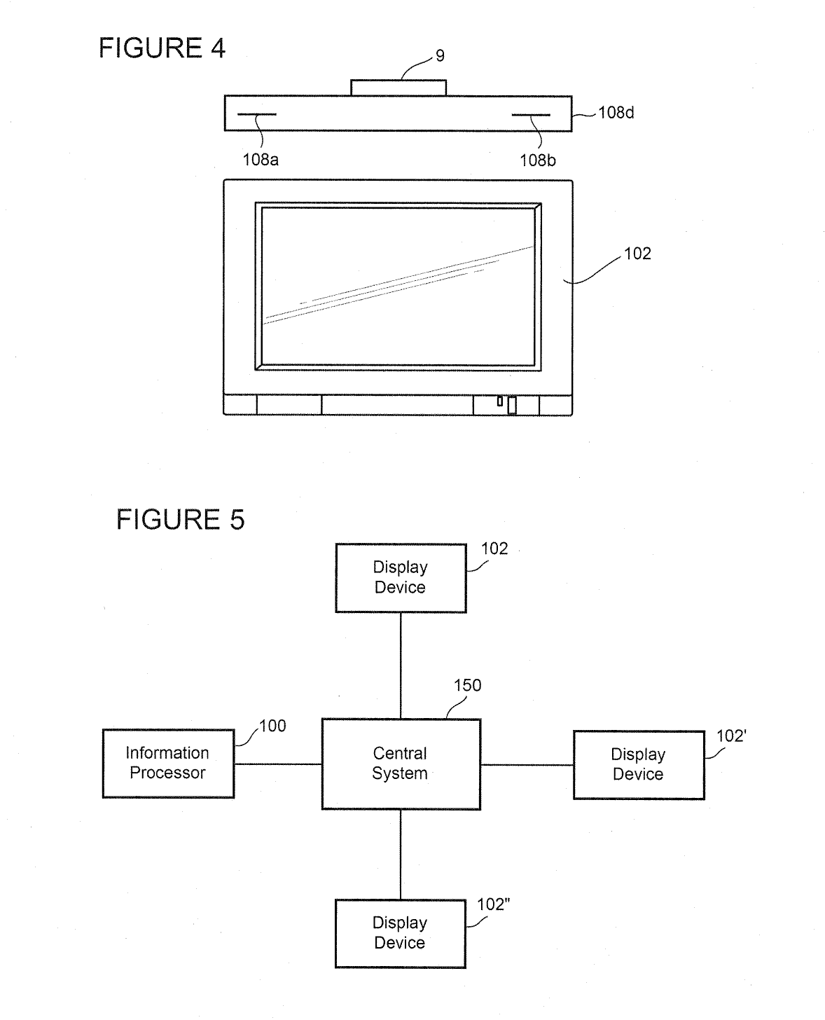

FIG. 4 illustrates light marking apparatus 108d being used with display device 102. Though light marking apparatus 108d is picture above display device 102, in other example embodiments the light marking apparatus may be positioned below the display device, on the side of the display device, etc. In some cases, a plurality of light marking apparatuses may be used with a corresponding plurality of display devices located in disparate locations.

In certain example embodiments, any wavelength of light may operate to charge the solar light marking apparatus. Furthermore, natural light may be used, or indoor lighting sources, or even handheld lighting sources that may be briefly shined upon the converter 9 in order to produce energy and/or electricity. Any source of electromagnetic radiation may be used to charge the solar light marking apparatus in different example embodiments.

Embodiments of the light marking apparatus 108d as described herein are advantageous in that they may be cordless. In some examples, the light marking apparatuses may not require batteries that will inevitably need to be recharged. However, in other example embodiments, the light marking apparatuses may include batteries as a power source. The light marking apparatus 108d may not need to be connected anything, making it more easily portable, in other example embodiments.

In certain example embodiments, the cordless light marking apparatus 108d may be used in close proximity to an information processor 100. In alternative embodiments, the cordless light marking apparatus 108d may advantageously be used in a different location and/or with a different display device/module than the one at which the information processor 100 is located. In these embodiments, so long as the handheld device and/or remote (e.g., controller 107) is within range of the information processor 100, and the display module/device 102 is connected (wirelessly, directly, indirectly, remotely, etc) to the information processor 100, games may be displayed on a display device 102 that is not directly proximate to an information processor 100. This may therefore enable multiple users to participate in the game via the same information processor (e.g., computer, game console, etc.) while using different display devices and/or while in different rooms.

This may be advantageous in certain example embodiments, because only one information processor (e.g., including a processor or console or the like) may be needed for a house, office, apartment, or the like, but the system may be accessed by one or multiple players in different rooms and/or on different display devices. Therefore, without needing to purchase more than one system (e.g., a game console, a computer, a handheld device, and/or the like), the same program (e.g., a game) may be accessed (e.g., played) by different users in different physical locations, so long as (1) each display device is remotely connected to a central system, to which the information processor may be connected; and (2) each user's remote is able to communicate with the processing system. This is advantageous in that the system, display devices and/or light marking apparatuses may never have to be physically moved in order for the program to be accessed in any room of the house and/or apartment and/or office, in certain example embodiments.

In certain exemplary embodiments of the invention, more than one light marking apparatus may be used in connection with only one information processor 100. In certain example embodiments, light marking apparatuses may be used with each appropriate display device (e.g., game playback device—televisions, computers, monitors, LED devices, LCD devices, plasma devices, display devices, and the like). For example and without limitation, more than one (e.g., several) display devices may each have a marking apparatus affixed near the device. However, each display device may be connected to the same information processor (wirelessly and/or through a wired connection), in certain example embodiments.

This also may enable multiple display devices associated with multiple respective cordless light marking apparatuses 108d to be used by multiple players simultaneously. More specifically, in certain example embodiments, more than one player may play the same game, on the same information processor 100, at the same time, but may use different display devices associated with a plurality of cordless light marking apparatuses 108d. This may be accomplished so long as each user's remote (e.g., controller 107) is able to communicate with the information processor 100.

Another aspect permits the light marking apparatus to be used to allow multiple users within a family house, to play the same game while in different rooms. A simple example is:

A father and his son were playing Ping-Pong in the living room lately and finally went to sleep. In the morning, they stay in their respective room but would like to finish the game without leaving their bed. By turning their room TV to a designated channel (linked to a centralized system), each of their respective display devices will receive the same Video and Audio signals sent out from the console. Because they have a cordless solar and/or self-powered light marking apparatus in their room, they are each able to get their remote working and finish the game. The same thing could apply to a situation involving a mom in the kitchen playing with a daughter in the basement.

Though a plurality of cordless light marking bars used with only one system is described herein, for simplicity, certain example embodiments relate to multiple cordless light marking apparatuses 108d being used in connection with fewer information processors 100 than the total number of cordless light marking apparatuses (and users). This may advantageously permit a light marking apparatus to remain stationary while the information processor is moved, etc., in certain examples. Thus, an information processor (e.g., game console, computer, etc.) may be used in different physical locations (e.g., with different display devices) without the need to move the light marking apparatuses. This may also advantageously enable multiple players to use different display devices in different physical locations and simultaneously play the same game via a signal emanating from the same information processor (e.g., as opposed to an online network connecting multiple consoles).

Thus, as described herein, it has advantageously been found that with solar and/or self-powered cordless light marking apparatuses, it is possible to play the same game on the same console from different locations; either simultaneously or at different times, without having to move the console and/or the light marking apparatus.

In certain example embodiments, this may be accomplished by connecting the information processor to a centralized media system. This may be a media distribution center, in certain example embodiments. The console may be connected to an AV distribution system or the like, in certain example embodiments. The information processor may be connected to any media system that provides signals and/or communicates with electronics and/or TV systems throughout a house, office, apartment, store, and/or the like.

A non-limiting example of a “central media system” is a network system using an audio-video (AV) signal as distributed signal throughout a building with a distributed AV system. A house distribution video system may be networked with one central information processor including a processor, game console and/or the like, using a solar and/or self-powered light marking apparatus as described herein with each connected display device. The information processor's AV output may be connected to the AV distribution system such that each TV and/or other display device connected to this central system can get to the appropriate channel and receive the Video and the Audio signals via that channel. The AV output may be connected to a local digital modulator to send out the signal as a wave. However, this invention is not so limited, and any centralized media system capable of sending the program's signal to any display device(s) connected to the centralized media system may be used.

In certain example embodiments, at each display device (e.g., TV and/or computer monitor or other output device that is connected to a central media system), a cordless solar and/or self-powered light marking apparatus may be provided. By tuning the TV and/or other output device to a particular channel, the TV can connect to the console even when they are in physically separate locations.

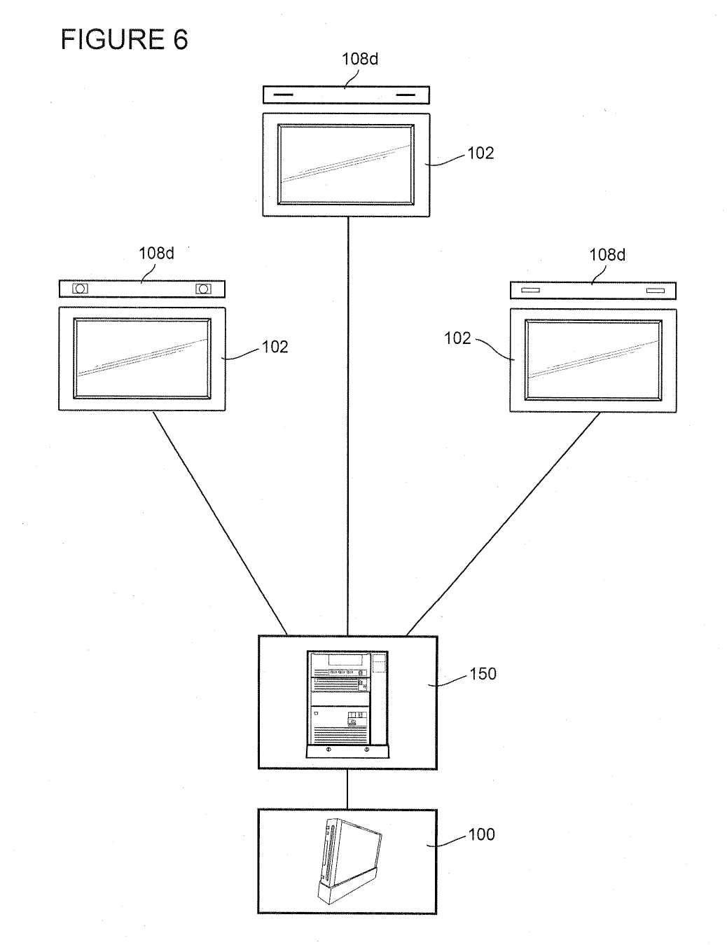

FIGS. 5-7 illustrate example embodiments of this aspect. More specifically, FIG. 5 illustrates a system comprising an information processor generating display signals; a display signal distributor that distributes the display signals to a plurality of disparately-located display devices; a plurality of handheld controllers each capable of wireless communication with the processor, each said handheld controller including an optical detector; a plurality of light marking arrays associated with the respective plurality of disparately-located displays, each light marking array being proximate an associated display device; the information processor wirelessly receiving pointing signals from the plurality of handheld controllers in response to detection of said associated light marking arrays by said handheld controller optical detectors, said information processor processing said received pointing signals to generate display signals representing an animated display sequence for common display by the plurality of disparately-located display devices.

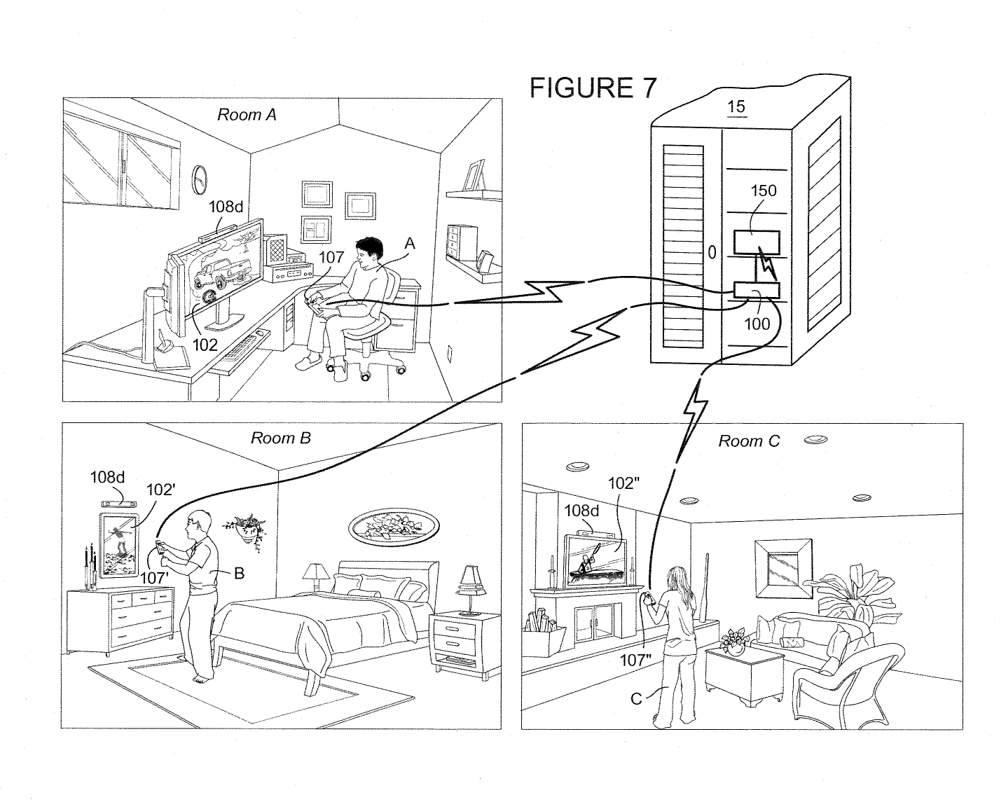

In other words, FIG. 5 illustrates a block diagram shows that multiple display devices (102, 102′, 102″) are connected to a central distribution system 150. Though three display devices are shown in FIGS. 5 and 6, fewer or more devices may be used. This central distribution system may be a home entertainment system in certain embodiments, such as an AV distribution system. It may be any centralized distribution system in other embodiments. An information processor 100 (e.g. game console, computer, and/or the like) is connected, either wirelessly or directly, to the central distribution system 150. Display device(s) is/are connected (e.g., wirelessly, directly, indirectly, remotely, etc) to the central distribution system 150. Through the central distribution system 150, users at each display device may access the information processor 100; e.g. on a particular channel or the like. Thus, each display device (102, 102′, 102″) is proximate a cordless light marking apparatus 108d. Each display device may be in a different physical location, but via the central distribution system 150, multiple players may access the information processor 100 such that they may simultaneously play a game together, in certain embodiments.

In certain example embodiments, controller(s) 107 connect to information processor 100 wirelessly. In some cases, this wireless connection may utilize Bluetooth technology. Bluetooth is a proprietary open wireless technology standard for exchanging data over short distances (using short wavelength radio transmissions in the ISM band from 2400-2480 MHz) from fixed and mobile devices, creating personal area networks (PANs) with high levels of security. In certain example embodiments, Bluetooth may connect and/or synchronize several devices. In certain example embodiments, Bluetooth may have a range of at least about 5 meters, more preferably about 10 meters, and most preferably at least about 100 meters. As technology develops, the range of Bluetooth technology may increase to greater distances than these, as would be understood by one skilled in the art. Further, because Bluetooth devices use a radio (broadcast) communications system, the devices do not have to be in visual line of sight of each other, in certain example embodiments. However, in some cases a quasi-optical wireless path may be needed.

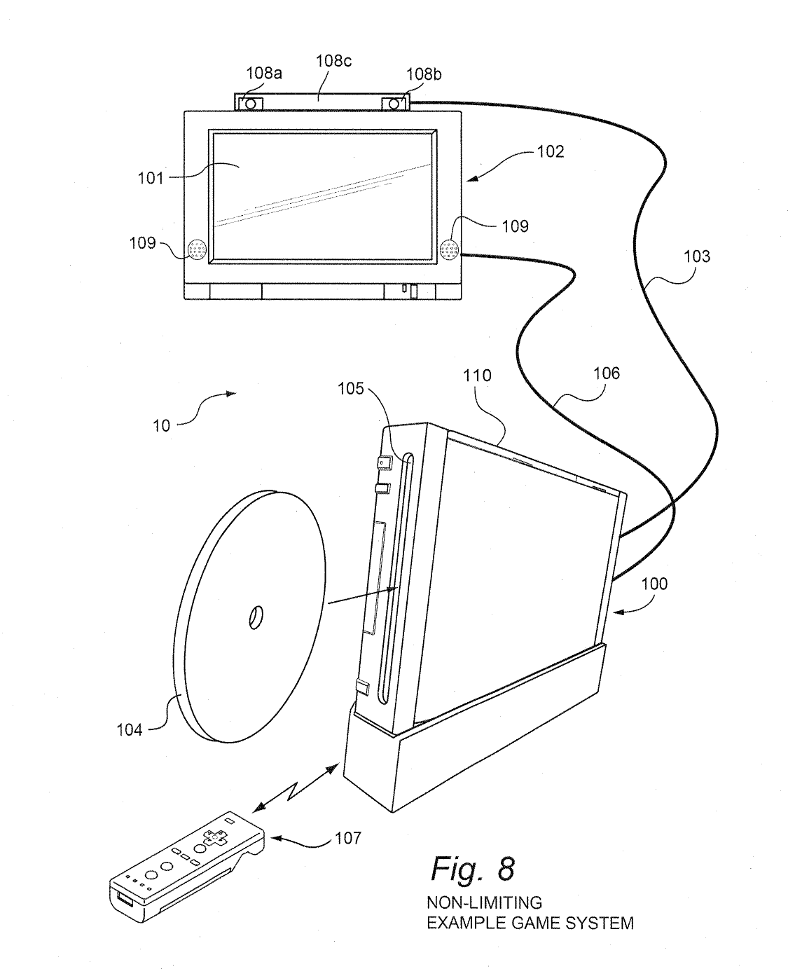

An example embodiment is further described in FIG. 7. FIG. 7 illustrates 3 players, each in a different room in a house/dwelling, each with their own display device and light marking apparatus, simultaneously sending and receiving data to/from the same information processor, from different physical locations.

More specifically, in FIG. 7, player A is in room A (e.g., a den or home office), with display device 102, cordless light marking apparatus 108d, and controller 107. Controller 107 connects wirelessly (shown by the lightning bolt; e.g. via Bluetooth) to information processor 100. Information processor 100 is connected to central (e.g., AV) distribution system 150 (wirelessly and/or with wires), and both are located in closet 15 (as a non-limiting example). Player B is in room B (e.g., a bedroom), with display device 102, cordless light marking apparatus 108d, and controller 107′, which is wirelessly connected to information processor 100. Room C (e.g., a living room) contains player C, who also has a cordless light marking apparatus 108d, as well as display device 102″, and controller 107″ which is wirelessly connected to information processor 100. In certain example embodiments, players A, B, and C may access a program executed by an information processor 100, and may interact with each other and the program via controllers 107 (e.g., as a non-limiting example, the information processor receives data from each of the user data input devices, and outputs video and/or audio signals to the central AV distribution system, which sends the information to each of the display devices).

In other embodiments, the connection a plurality of display devices 102, 102′, 102″ (each having their own respective cordless light marking apparatus 108d) to a central distribution system 150 simply permits a single player to access the same information processor 100 through different display devices (102, 102′, 102″), without the need to move the information processor 100 or the cordless light marking apparatus 108d.

This set up may advantageously enable (1) more than one player to play a game on the same information processor simultaneously from different physical locations (e.g., more than 10 or 20 feet apart, in different rooms, etc.) and/or (2) the information processor to be used/accessed at different times from different locations without having to move the processing system and/or the cordless light marking apparatus to a different location to do so.

Therefore, through the use of cordless light marking apparatuses and a centralized distribution system, an information processor may be accessed from multiple display devices, without the need for moving the cordless light marking apparatuses or the information processor. The information processor may be accessed substantially simultaneously, by more than one player, using more than one display device, and more than one pointing/controlling device, in certain embodiments. In other embodiments, the information processor may be accessed at different times from different display devices, with different pointing/controlling devices, by any number of players (e.g., one player, two players, etc).

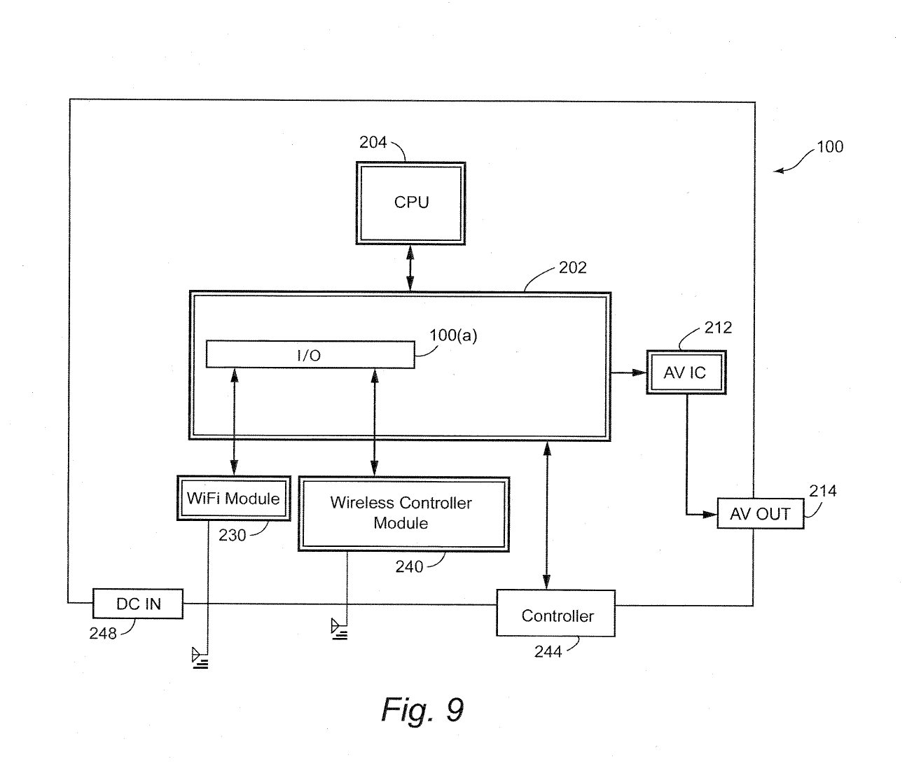

FIG. 8 shows a non-limiting example system 10 including an information processor 100, a display device 102 (e.g., a television, computer monitor, screen, etc.) and a controller 107. In certain example embodiments, the information processor may include at least one processor 100(a). In certain examples, the information processor may be a video game system, a game console, a computer, a server, and/or the like. In certain example embodiments, the information processor may be portable.

In certain example embodiments, information processor 100 may be part of a computer and/or the like. In other example embodiments, information processor 100 may be a console (e.g., a game console). In some cases, information processor 100 causes a program or other application stored on optical disc 104 inserted into slot 105 formed in housing 110 thereof to be executed. The result of the execution of the program or other application is displayed on display screen 101 of display device 102 to which information processor 100 is connected by cable 106. Audio associated with the program or other application is output via speakers 109 of display device 102. While an optical disk is shown in FIG. 8, the program or other application (e.g., game program) may alternatively or additionally be stored on other storage media such as semiconductor memories, magneto-optical memories, magnetic memories and the like. Further, while a television was given as an example of 102, 102 may illustrate any type of display device (e.g., CRT television, LCD, LED and/or plasma television, computer display, laptop, and the like).

Controller 107 wirelessly transmits data such as game control data to the information processor 100. The game control data may be generated using an operation section of controller 107 having, for example, a plurality of operation buttons, a key, a stick and the like. Controller 107 may also wirelessly receive data transmitted from information processor 100. Any one of various wireless protocols such as Bluetooth (registered trademark) may be used for the wireless transmissions between controller 107 and information processor 100.

As discussed below, controller 107 also includes an imaging information calculation section for capturing and processing images from light-emitting device (e.g., light marking apparatus) 108c/d with light sources 108a and 108b. Although light marking apparatus 108c/d is shown in FIG. 8 as being above display device 102, it may also be positioned below display device 102. In one implementation, a center point between light sources 108a and 108b is substantially aligned with a vertical center-line of display screen 101. The images from light sources 108a and 108b can be used to determine a direction in which controller 107 is pointing as well as a distance of controller 107 from display screen 101. Light-emitting device 108c/d may comprise at least two light sources 108a and 108b in some embodiments. In further embodiments, more than two light sources may be provided.

In certain example embodiments, light-emitting device 108c/d comprising at least light sources 108a and 108b may be implemented as, e.g., a light marking apparatus comprising a plurality of LED modules/sources (hereinafter, referred to as “markers”) provided in the vicinity of the display screen of display device 102. In certain example embodiments, light marking apparatus 108c may be referred to as an array or a sensor bar. Markers 108a and 108b may each output infrared light and the imaging information calculation section of controller 107 detects the light output from the LED modules to determine a direction in which controller 107 is pointing and a distance of controller 107 from display 101 as mentioned above.

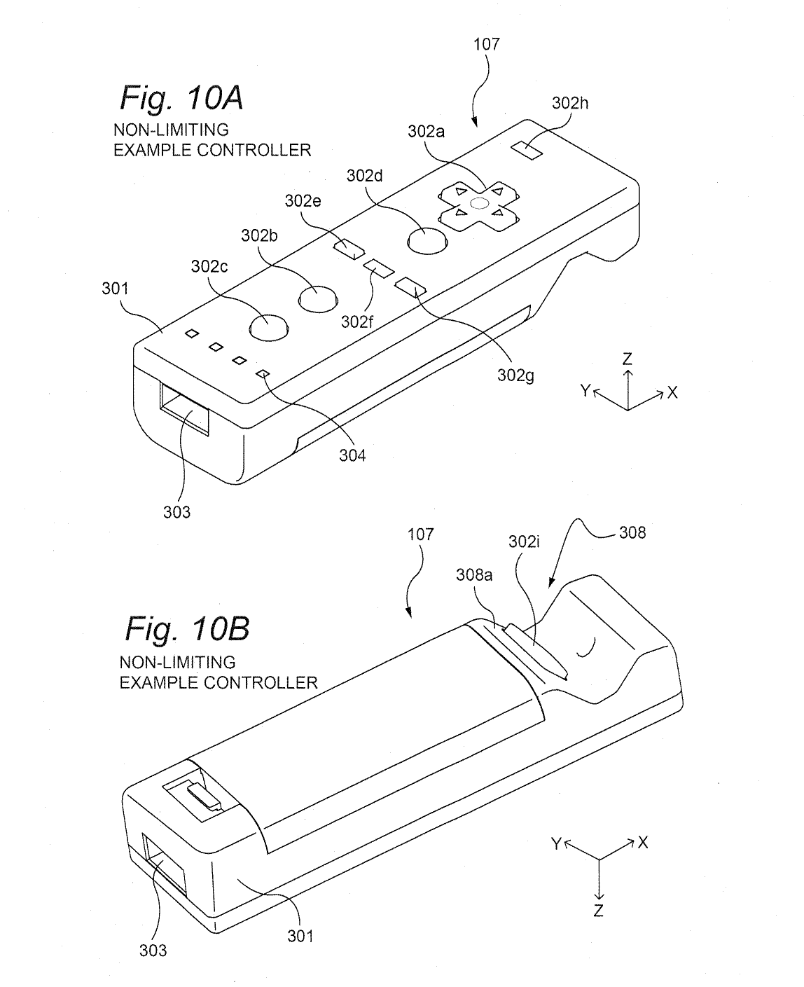

With reference to the block diagram of FIG. 9, a simplified information processor is shown. Information processor 100 may include system 202 with processor 100(a), which may include a central processing unit (CPU) (e.g., RISC) 204 for executing various types of applications including (but not limited to) computer programs and/or video game programs. CPU 204 executes a boot program stored, for example, in a boot ROM to initialize processor 100(a) and then executes an application (or applications) stored on an optical disk, a USB flash drive, or in a flash and/or main memory (not pictured). In some example embodiments, information processor 100 may include a video processor.

WiFi module 230 enables information processor 100 to be connected to a wireless access point. The access point may provide internet connectivity for on-line gaming with players at other locations (with or without voice chat capabilities), as well as web browsing, e-mail, file downloads (including game downloads) and many other types of on-line activities. In some implementations, WiFi module 230 may also be used for communication with other game devices such as suitably-equipped hand-held game devices. Module 230 is referred to herein as “WiFi”, which is generally a designation used in connection with the family of IEEE 802.11 specifications. However, information processor 100 may of course alternatively or additionally use wireless modules that conform to other wireless standards.

Wireless controller module 240 receives signals wirelessly transmitted from one or more controllers 107 and provides these received signals to processor 100(a). The signals transmitted by controller 107 to wireless controller module 240 may include signals generated by controller 107 itself as well as by other devices that may be connected to controller 107. By way of example, some games may utilize separate right- and left-hand inputs. For such games, another controller (not shown) may be connected (e.g., by a wired connection) to controller 107 and controller 107 can transmit to wireless controller module 240 signals generated by itself and by the other controller.

Wireless controller module 240 may also wirelessly transmit signals to controller 107. By way of example without limitation, controller 107 (and/or another game controller connected thereto) may be provided with vibration circuitry and vibration circuitry control signals may be sent via wireless controller module 240 to control the vibration circuitry (e.g., by turning the vibration circuitry on and off). By way of further example without limitation, controller 107 may be provided with (or be connected to) a speaker (not shown) and audio signals for output from this speaker may be wirelessly communicated to controller 107 via wireless controller module 240. By way of still further example without limitation, controller 107 may be provided with (or be connected to) a display device (not shown) and display signals for output from this display device may be wirelessly communicated to controller 107 via wireless controller module 240.

In certain examples, one or more controller connectors 244 may be adapted for wired connection to respective game controllers. Alternatively, respective wireless receivers may be connected to connectors 244 to receive signals from wireless game controllers. These connectors enable players, among other things, to use controllers to interact with an information processor 100 when an optical disk for a game developed for this platform is inserted into optical disk drive 208.

A connector 248 is provided for connecting information processor 100 to DC power derived, for example, from an ordinary wall outlet. Of course, the power may be derived from one or more batteries. Further, AV IC 212 is connected to connector 214, which may output audio and/or video signals.

Information processor 100 may include other features which are not shown in certain example embodiments. A more detailed description of information processor 100, particularly when information processor 100 is a video game console, can be found in U.S. patent application Ser. No. 12/149,921, which is hereby incorporated by reference.

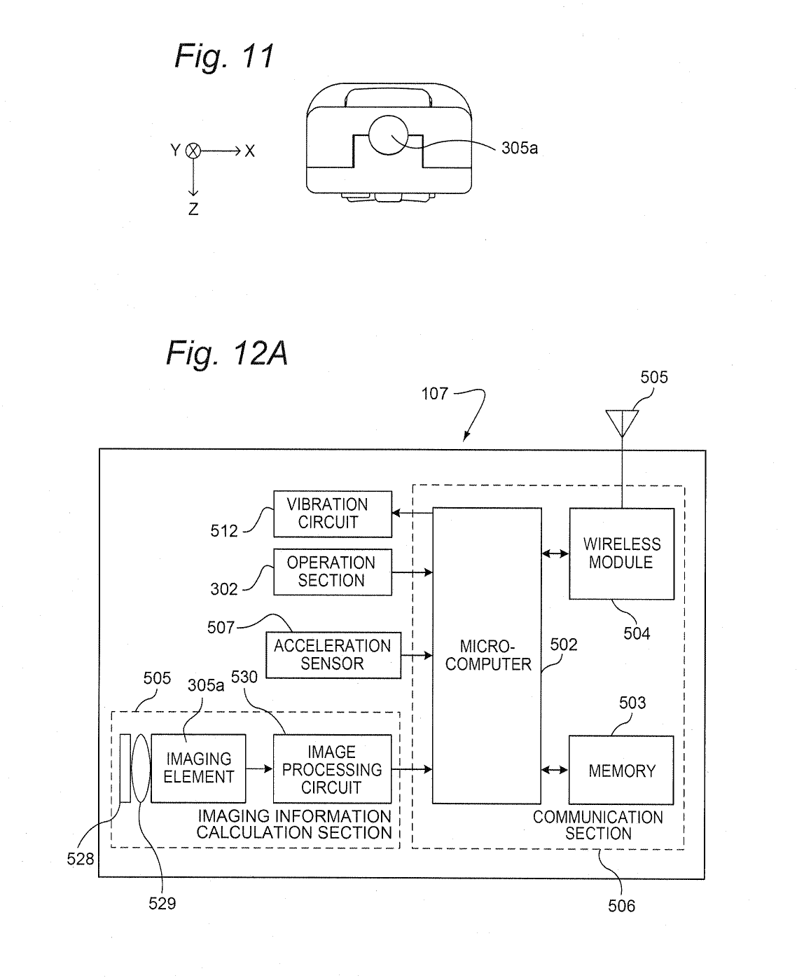

For ease of explanation in what follows, a coordinate system for controller 107 will be defined. As shown in FIGS. 10(a)-(b) and 11, a left-handed X, Y, Z coordinate system has been defined for controller 107. Of course, this coordinate system is described by way of example without limitation and the systems and methods described herein are equally applicable when other coordinate systems are used.

As shown in the block diagram of FIG. 10A, controller 107 includes a three-axis, linear acceleration sensor 507 that detects linear acceleration in three directions, i.e., the up/down direction (Z-axis shown in FIGS. 3 and 4), the left/right direction (X-axis shown in FIGS. 8 and 9), and the forward/backward direction (Y-axis shown in FIGS. 8 and 9). Alternatively, a two-axis linear accelerometer that only detects linear acceleration along each of the Y-axis and Z-axis, for example, may be used or a one-axis linear accelerometer that only detects linear acceleration along the Z-axis, for example, may be used. Generally speaking, the accelerometer arrangement (e.g., three-axis or two-axis) will depend on the type of control signals desired. As a non-limiting example, the three-axis or two-axis linear accelerometer may be of the type available from Analog Devices, Inc. or STMicroelectronics N.V. Preferably, acceleration sensor 507 is an electrostatic capacitance or capacitance-coupling type that is based on silicon micro-machined MEMS (micro-electromechanical systems) technology. However, any other suitable accelerometer technology (e.g., piezoelectric type or piezoresistance type) now existing or later developed may be used to provide three-axis or two-axis linear acceleration sensor 507.

As one skilled in the art understands, linear accelerometers, as used in acceleration sensor 507, are only capable of detecting acceleration along a straight line corresponding to each axis of the acceleration sensor. In other words, the direct output of acceleration sensor 507 is limited to signals indicative of linear acceleration (static or dynamic) along each of the two or three axes thereof. As a result, acceleration sensor 507 cannot directly detect movement along a non-linear (e.g. arcuate) path, rotation, rotational movement, angular displacement, tilt, position, attitude or any other physical characteristic.

However, through additional processing of the linear acceleration signals output from acceleration sensor 507, additional information relating to controller 107 can be inferred or calculated (i.e., determined), as one skilled in the art will readily understand from the description herein. For example, by detecting static, linear acceleration (i.e., gravity), the linear acceleration output of acceleration sensor 507 can be used to determine tilt of the object relative to the gravity vector by correlating tilt angles with detected linear acceleration. In this way, acceleration sensor 507 can be used in combination with micro-computer 502 of controller 107 (or another processor) to determine tilt, attitude or position of controller 107. Similarly, various movements and/or positions of controller 107 can be calculated through processing of the linear acceleration signals generated by acceleration sensor 507 when controller 107 containing acceleration sensor 507 is subjected to dynamic accelerations by, for example, the hand of a user.

In another embodiment, acceleration sensor 507 may include an embedded signal processor or other type of dedicated processor for performing any desired processing of the acceleration signals output from the accelerometers therein prior to outputting signals to micro-computer 502. For example, the embedded or dedicated processor could convert the detected acceleration signal to a corresponding tilt angle (or other desired parameter) when the acceleration sensor is intended to detect static acceleration (i.e., gravity).

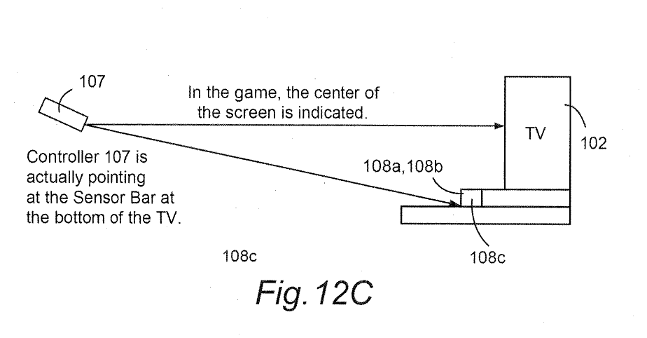

Returning to FIG. 12A, imaging information calculation section 505 of controller 107 includes infrared filter 528, lens 529, imaging element 305a and image processing circuit 530. Infrared filter 528 allows only infrared light to pass therethrough from the light that is incident on the front surface of controller 107. Lens 529 collects and focuses the infrared light from infrared filter 528 on imaging element 305a. Imaging element 305a is a solid-state imaging device such as, for example, a CMOS sensor or a CCD. Imaging element 305a captures images of the infrared light from light marking apparatus 108c including light sources 108a and 108b, collected by lens 529. Accordingly, imaging element 305a captures images of only the infrared light that has passed through infrared filter 528 and generates image data based thereon. This image data is processed by image processing circuit 530 which detects an area thereof having high brightness, and, based on this detecting, outputs processing result data representing the detected coordinate position and size of the area to communication section 506. From this information, the direction in which controller 107 is pointing and the distance of controller 107 from display 101 can be determined.

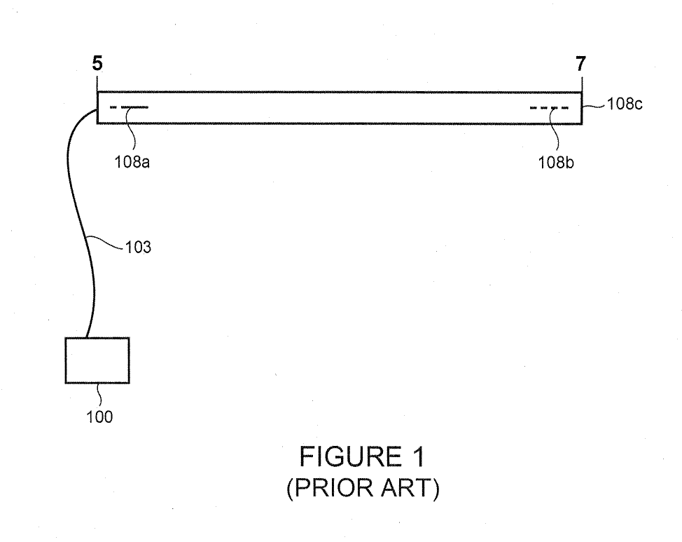

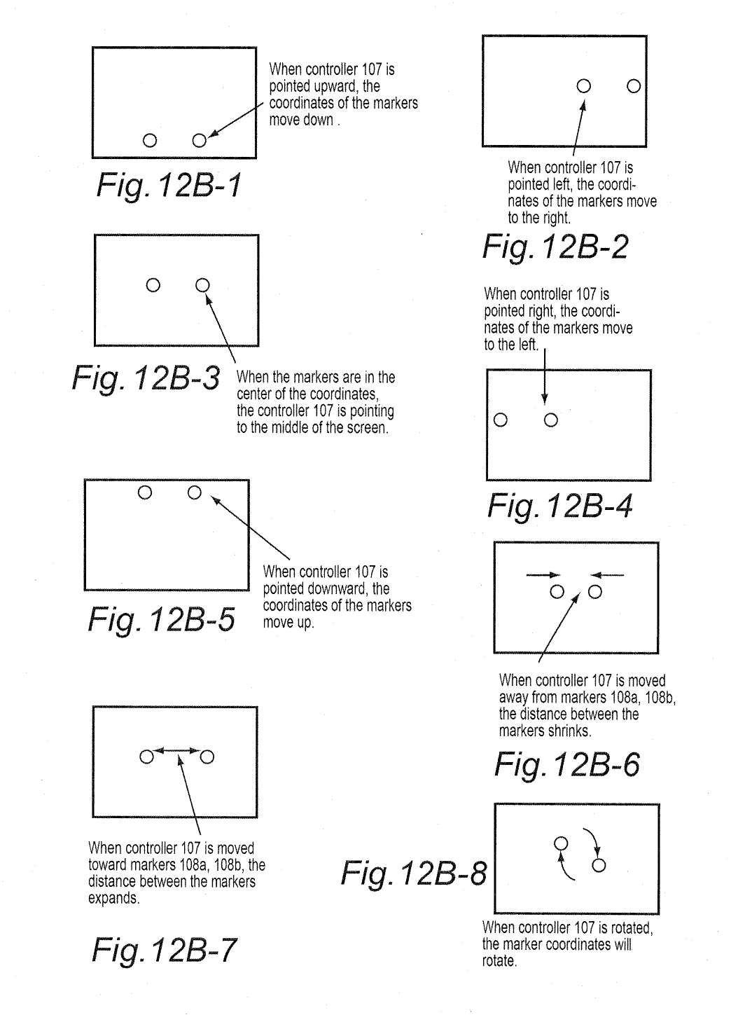

FIGS. 12B-1 to 12B-8 show how a rotation of the controller or a direction in which controller 107 is pointing can be determined using markers 108a, 108b of the light marking apparatus 108c. In this example implementation, controller 107 points to the intermediate coordinates of the two markers on the light marking apparatus. In an example implementation, the pointer coordinates are 0-1023 on the X-axis and 0-767 on the Y-axis. With reference to FIG. 12B-1, when controller 107 is pointed upward, the coordinates of the markers detected at remote control 107 move down. With reference to FIG. 12B-2, when controller 107 is pointed left, the coordinates of the markers move to the right. With reference to FIG. 12B-3, when the markers are centered, remote controller 107 is pointed at the middle of the screen. With reference to FIG. 12B-4, when controller 107 is pointed right, the coordinates of the markers move to the left. With reference to FIG. 12B-5, when controller 107 is pointed downward, the coordinates of the markers move up. With reference to FIG. 12B-6, when controller 107 is moved away from markers 108a, 108b of light marking apparatus 108c, the distance between the markers is reduced. With reference to FIG. 12B-7, when controller 107 is moved toward markers 108a, 108b, the distance between the markers increases. With reference to FIG. 12B-8, when controller 107 is rotated, the marker coordinates will rotate.

FIG. 12C shows light marking apparatus 108c (e.g., array, sensor bar, etc.) with markers 108a, 108b positioned below the display screen 101 of the television 102. As shown in FIG. 12C, when controller 107 is pointing toward the sensors, it is not actually pointing at the center of display screen 101. However, the game program or application executed by game machine 100 may treat this situation as one in which controller 107 is pointed at the center of the screen. In this case, the actual coordinates and the program coordinates will differ, but when the user is sufficiently far from the television, his or her brain automatically corrects for the difference between the coordinates seen by the eye and the coordinates for hand movement.

Again returning to FIG. 12A, vibration circuit 512 may also be included in controller 107. Vibration circuit 512 may be, for example, a vibration motor or a solenoid. Controller 107 is vibrated by actuation of the vibration circuit 512 (e.g., in response to signals from information processor 100), and the vibration is conveyed to the hand of the player grasping controller 107. Thus, a so-called vibration-responsive game may be realized.

As described above, acceleration sensor 507 detects and outputs the acceleration in the form of components of three axial directions of controller 107, i.e., the components of the up-down direction (Z-axis direction), the left-right direction (X-axis direction), and the front-rear direction (the Y-axis direction) of controller 107. Data representing the acceleration as the components of the three axial directions detected by acceleration sensor 507 is output to communication section 506. Based on the acceleration data which is output from acceleration sensor 507, a motion of controller 107 can be determined.

Communication section 506 includes micro-computer 502, memory 503, wireless module 504 and antenna 505. Micro-computer 502 controls wireless module 504 for transmitting and receiving data while using memory 503 as a storage area during processing. Micro-computer 502 is supplied with data including operation signals (e.g., cross-switch, button or key data) from operation section 302, acceleration signals in the three axial directions (X-axis, Y-axis and Z-axis direction acceleration data) from acceleration sensor 507, and processing result data from imaging information calculation section 505. Micro-computer 502 temporarily stores the data supplied thereto in memory 503 as transmission data for transmission to information processor 100. The wireless transmission from communication section 506 to information processor 100 is performed at predetermined time intervals. Because game processing is generally performed at a cycle of 1/60 sec. (16.7 ms), the wireless transmission is preferably performed at a cycle of a shorter time period. For example, a communication section structured using Bluetooth (registered trademark) technology can have a cycle of 5 ms. At the transmission time, micro-computer 502 outputs the transmission data stored in memory 503 as a series of operation information to wireless module 504. Wireless module 504 uses, for example, Bluetooth (registered trademark) technology to send the operation information from antenna 505 as a carrier wave signal having a specified frequency. Thus, operation signal data from operation section 302, the X-axis, Y-axis and Z-axis direction acceleration data from acceleration sensor 507, and the processing result data from imaging information calculation section 505 are transmitted from controller 107. Information processor 100 receives the carrier wave signal and demodulates or decodes the carrier wave signal to obtain the operation information (e.g., the operation signal data, the X-axis, Y-axis and Z-axis direction acceleration data, and the processing result data). Based on this received data and the application currently being executed, CPU 204 of information processor 100 may perform application processing. If communication section 506 is structured using Bluetooth (registered trademark) technology, controller 107 can also receive data wirelessly transmitted thereto from devices including information processor 100.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A system comprising:
an information processor generating display signals;
a display signal distributor that distributes the display signals to a plurality of disparately-located display devices;
a plurality of handheld controllers each capable of wireless communication with the processor, each said handheld controller including an optical detector;
a plurality of light marking arrays associated with the respective plurality of disparately-located displays, each light marking array being proximate an associated display device;
the information processor wirelessly receiving pointing signals from the plurality of handheld controllers in response to detection of said associated light marking arrays by said handheld controller optical detectors, said information processor processing said received pointing signals to generate display signals representing an animated display sequence for common display by the plurality of disparately-located display devices.

2. A method comprising:
receiving first user input data from a first user input device;
receiving second user input data from a second user input device;
performing a process on an information processor including at least one processor, based on the first and second received user input data;
the information processor outputting video signal to first and second display devices, wherein the first and second display devices are located in disparate physical locations, and wherein first and second display devices are proximate first and second cordless light marking apparatuses, respectively.

3. The method of claim 2, wherein the processor is coupled to a central audio-visual system.

4. The method of claim 2, wherein the information processor outputs video signal to the central AV system, which in turn outputs the video signal to the first and second display devices.

5. The method of claim 2, wherein the first and second cordless light marking apparatuses comprising plural point source arrays, each array including at least one light source for supplying an unmodulated, substantially constant illumination intensity; and at least one housing for supporting the plural point source arrays with a fixed predetermined distance therebetween, said housing between adapted to mount either above or beneath a display device, at least a power source, provided on said housing, wherein the power source provides power to the light source, are proximate first and second display devices, respectively.

6. The method of claim 5, wherein the power source of at least the first cordless light marking apparatus comprises a solar cell.

7. The method of claim 5, wherein the power sources of the first and second cordless light marking apparatuses comprise solar cells.

8. The method of claim 5, wherein the power sources of the first and second cordless light marking apparatuses comprise batteries.

9. The method of claim 2, wherein first and second display devices are located in different rooms.

10. A cordless light marking apparatus comprising:
plural point source arrays, each array including at least one light source for supplying an unmodulated, substantially constant illumination intensity; and
at least one housing for supporting the plural point source arrays with a fixed predetermined distance therebetween, said housing between adapted to mount either above or beneath a display device,
at least solar energy conversion device, provided on said housing, wherein the cell provides power to the light source,
wherein said light marking apparatus can, without modification or customization, be used with a variety of differently sized display devices.

11. The cordless light marking apparatus of claim 10, wherein the solar energy conversion device comprises a solar cell, and uses visible light to power the light source.

12. The cordless light marking apparatus of claim 10, wherein the solar energy conversion device comprises a photovoltaic device, and uses infrared radiation to power the light source.

13. The cordless light marking apparatus of claim 10, wherein the solar energy conversion device comprises a photovoltaic device, and uses ultraviolet radiation to power the light source.

14. A system comprising:
the cordless light marking apparatus of claim 10 provided proximate a display device, wherein the display device is connected to an information processor via a central system, such that more than one display device each having its own light marking apparatus may display a program executed by the information processor substantially simultaneously.

15. A system comprising:
the cordless light marking apparatus of claim 10 provided proximate a display device, wherein the display device is connected to a game console comprising an information processer via a central system, such that the processor may be accessed by more than one display device each having its own light marking apparatus.

16. A method of playing a game, the method comprising:
providing the cordless light marking apparatus of claim 10 proximate a display device, wherein the display device is connected to a game console comprising an information processor via a central distribution system, such that more than one display device may display a game played via the game console substantially simultaneously.

17. The method of claim 16, wherein at least two display devices are located in disparate physical locations, and wherein each display device is proximate a light marking apparatus.

18. The method of claim 17, wherein the first display device and light marking apparatus are located in a first room in a dwelling, and the second display device and light marking apparatus are located in a second room in a dwelling.

19. The system of claim 15, wherein at least two display devices are located in disparate physical locations, and wherein each display device is proximate a light marking apparatuses.

20. The system of claim 19, wherein the first display device and light marking apparatus are located in a first room in a dwelling, and the second display device and light marking apparatus are located in a second room in a dwelling.
